(19) United States
(12) Patent Application Publication
(10) Pub. No.: US 2015/0381567 A1
(43) Pub. Date: Dec. 31, 2015

(54) CLEARTEXT GATEWAY FOR SECURE ENTERPRISE COMMUNICATIONS

(71) Applicants: Robert A. Johnson, Malvern, PA (US); Sarah K. Inforzato, Malvern, PA (US)

(72) Inventors: Robert A. Johnson, Malvern, PA (US); Sarah K. Inforzato, Malvern, PA (US)

(73) Assignee: UNISYS CORPORATION, Blue Bell, PA (US)

(21) Appl. No.: 14/753,437

(22) Filed: Jun. 29, 2015

Related U.S. Application Data
(60) Provisional application No. 62/018,802, filed on Jun. 30, 2014.

(51) Int. Cl. H04L 29/06; H04L 12/931; H04L 12/741; H04L 29/12

(52) U.S. Cl. CPC H04L 63/0227; H04L 61/2007; H04L 49/70; H04L 45/54; H04L 61/6068

(57) ABSTRACT

A gateway computing system includes a memory storing cleartext gateway software and a programmable circuit communicatively connected to the memory. The programmable circuit is configured to execute computer-executable instructions including the cleartext gateway software. Execution of the cleartext gateway software by the programmable circuit causes the gateway computing system to instantiate at the gateway computing system a virtual device router including a cleartext interface configured to send and receive data packets from a cleartext endpoint and a secured interface configured to exchange data packets with one or more secured endpoints within a secured enterprise network, and load the virtual device router with community of interest material from an authentication server, the community of interest material associated with one or more communities of interest configured to allow access to the cleartext endpoint.

### CROSS-REFERENCE TO RELATED APPLICATIONS

The present application claims priority from U.S. Provisional Patent Application No. 62/018,802 filed on Jun. 30, 2014, Attorney Docket No. TN622.P, the disclosure of which is hereby incorporated by reference in its entirety.

The present application is also related to, and claims priority from the following related and commonly assigned U.S. patent applications:

1. U.S. Provisional patent application entitled: Distributed Security on Multiple Independent Networks using Secure “Parsing” Technology, by Robert Johnson, Attorney Docket No. TN400.P, Ser. No. 60/648,531, filed 31 Jan., 2005;

2. U.S. patent application entitled: Integrated Multi-Level Security System, by Robert Johnson, Attorney Docket No. TN400.U.S. Ser. No. 11/339,974 filed 26 Jan. 2006 claiming the benefit of the above provisional applications;

3. U.S. patent application entitled: Integrated Multi-Level Security System, by Robert Johnson et al., Attorney Docket No. TN400.USCIP1, Ser. No. 11/714,590 filed 6 Mar. 2007 which is a continuation-in-part of U.S. application Ser. No. 11/339,974;

4. U.S. patent application entitled: Integrated Multi-Level Security System, by Robert Johnson et al., Attorney Docket No. TN400.USCIP2, Ser. No. 11/714,666 filed 6 Mar. 2007 which is a continuation-in-part of U.S. application Ser. No. 11/339,974; and

5. U.S. patent application entitled: Integrated Multi-Level Security System, by Robert Johnson et al., Attorney Docket No. TN400.USCIP3, Ser. No. 11/714,598 filed 6 Mar. 2007 which is a continuation-in-part of U.S. application Ser. No. 11/339,974.

6. U.S. patent application Ser. No. 12/272,012, entitled “Block Level Data Storage Security System”, filed 17 Nov. 2008, Attorney Docket No. TN497. The present disclosure also claims the benefit of commonly assigned U.S. patent application Ser. No. 12/336,558, entitled “Data Recovery Using Error Strip Identifiers”, filed 17 Dec. 2008, Attorney Docket No. TN494.

7. U.S. patent application Ser. No. 12/336,559 entitled “Storage Security Using Cryptographic Splitting”, filed 17 Dec. 2008, Attorney Docket No. TN496; U.S. patent application Ser. No. 12/336,562, entitled “Storage Security Using Cryptographic Splitting”, filed 17 Dec. 2008, Attorney Docket No. TN496A; U.S. patent application Ser. No. 12/336,564, entitled “Storage Security Using Cryptographic Splitting”, filed 17 Dec. 2008, Attorney Docket No. TN496B; and U.S. patent application Ser. No. 12/336,568, entitled “Storage Security Using Cryptographic Splitting”, filed 17 Dec. 2008, Attorney Docket No. TN504A.

8. U.S. patent application Ser. No. 12/342,636 entitled “Storage Communities Of Interest Using Cryptographic Splitting”, filed 23 Dec. 2008, Attorney Docket No. TN498. U.S. patent application Ser. No. 12/342,575, entitled “Storage Communities Of Interest Using Cryptographic Splitting”, filed 23 Dec. 2008, Attorney Docket No. TN498A, U.S. patent application Ser. No. 12/342,610, entitled “Storage Communities Of Interest Using Cryptographic Splitting”, filed 23 Dec. 2008, Attorney Docket No. TN498B.

9. U.S. patent application Ser. No. 12/342,379, entitled “Secure Network Attached Storage Device Using Cryptographic Splitting”, filed 23 Dec. 2008, Attorney Docket No. TN499.

10. U.S. patent application Ser. No. 13/493,023, entitled “Software Handling Of Hardware Error Handling In Hypervisor-Based Systems”, filed 5 Sep. 2012, Attorney Docket No. TN550.

11. U.S. patent application Ser. No. 13/547,148, entitled “Automated Provisioning of Virtual Machines”, filed 12 Jul. 2012, Attorney Docket No. TN565.

The disclosures of each of these applications are hereby incorporated by reference in its entirety as if set forth in this application.

### TECHNICAL FIELD

The present disclosure relates generally to security arrangements for cloud computing. In particular, the present disclosure relates to a cleartext gateway for secure enterprise communications.

### BACKGROUND

Modern organizations generate store, and communicate large quantities of data. In many instances, organizations include individuals having different rights to data, or different rights to communicate with other individuals or access particular computing resources. It is frequently important that such organizations be able to quickly and securely access the data stored at the data storage system. In addition, it is frequently important that data stored at a data storage system, or communicated between computing systems, be recoverable if the data is communicated or written incorrectly or are otherwise intercepted or corrupted.

To address the above issues, Unisys Corporation of Blue Bell, Pa. developed a Stealth solution that uses a kernel-level driver to implement end-to-end cryptographic connections for communication of data across public and private networks. This solution allows users to communicate with other users having common user rights, while segregating user groups by way of assignment of different cryptographic keys used for each user group, or “community of interest”. However, the Stealth solution has some drawbacks. For example, such solutions lack capabilities to allow connection by remote devices to a network, and to allow connection of devices that are incapable of implementing particular security features that are used by the Stealth solution. Most recently, the Stealth solution has been extended to accommodate usage of an “off the shelf” Internet Protocol Security (IPsec)-based security protocol as a basis for some aspects of the Stealth solution. IPsec is an end-to-end security scheme of the Internet Protocol Suite. As compared to other security systems, such as SSL, SSH, or TLS, IPsec operates in the Internet Layer rather than operating in the upper layers of the TCP/IP model. Hence, IPsec protects any application traffic across an Internet Protocol (IP) network. Applications do not need to be specifically designed to use IPsec, whereas TLS/SSL is required to be designed into an application to protect the application protocols. In addition, IPsec operates in both IPv4 and IPv6-enabled networks.

However, existing IPsec-enabled systems typically negotiate to create IPsec tunnels, or secure tunnels, on a point-to-point basis, rather than allowing for data access by multiple entities within the same “community of interest”. Furthermore, IPsec is only available on some modern computing systems, and may be limited in availability in different types of systems, such as mobile devices, or in cloud environments. Furthermore, different implementations of IPsec on different types of computing systems are handled differently, leading to inconsistencies in connection parameters. Furthermore, IPsec is built based on a premise that two computing systems can negotiate security parameters; when two such systems intend to form a secure tunnel, that tunnel is established through use of an IKE key exchange, which requires a response to an initial transmission. However, to accomplish perfect forward secrecy, such trading of security parameters may not be possible.

Accordingly, mechanisms for improving flexibility by which devices can connect to and communicate with other devices within a Stealth-based network are desirable.

### SUMMARY

In summary, the present disclosure relates generally to security arrangements for cloud computing. In particular, the present disclosure relates to a cleartext gateway for secure enterprise communications.

In a first aspect, a gateway computing system includes a memory storing cleartext gateway software and a programmable circuit communicatively connected to the memory. The programmable circuit is configured to execute computer-executable instructions including the cleartext gateway software. Execution of the cleartext gateway software by the programmable circuit causes the gateway computing system to instantiate at the gateway computing system a virtual device router including a cleartext interface configured to send and receive data packets from a cleartext endpoint and a secured interface configured to exchange data packets with one or more secured endpoints within a secured enterprise network, and load the virtual device router with community of interest material from an authentication server, the community of interest material associated with one or more communities of interest configured to allow access to the cleartext endpoint.

In a second aspect, a method of routing traffic between a cleartext endpoint and a secured enterprise network includes instantiating at a gateway computing system a virtual device router associated with the cleartext endpoint; the virtual device router including a cleartext interface configured to send and receive data packets from a cleartext endpoint and a secured interface configured to exchange data packets with one or more secured endpoints within a secured enterprise network. The method further includes loading the virtual device router with community of interest material from an authentication server, the community of interest material associated with one or more communities of interest configured to allow access to the cleartext endpoint.

In a third aspect, a secured enterprise network allowing connection to a cleartext endpoint is disclosed. The secured enterprise network includes a plurality of secured endpoints configured to exchange secured communications among endpoints sharing a common community of interest, and a gateway computing system communicatively connected to the plurality of secured endpoints. The gateway computing system includes a virtual device router including a cleartext interface configured to send and receive data packets from a cleartext endpoint and a secured interface configured to exchange data packets with one or more secured endpoints within a secured enterprise network. The virtual device router includes community of interest material from an authentication server, the community of interest material associated with one or more communities of interest configured to allow access to the cleartext endpoint.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example architecture in which aspects of the present disclosure can be implemented;

FIG. 2 illustrates an example architecture including a cleartext gateway computing device in the context of a secure enterprise network;

FIG. 3 illustrates an example virtual data relay instantiable within a cleartext gateway computing device to establish a cleartext connection to an endpoint not resident within the secure enterprise network;

FIG. 4 is a flowchart of a method for instantiating virtual data relays in a cleartext gateway computing device, according to an example embodiment of the present disclosure;

FIG. 5 is a flowchart of a method for configuring networking settings for a virtual data relay within a gateway computing device, according to an example embodiment;

FIG. 6 is a flowchart of a method for communicating with an external endpoint from a secure enterprise network, according to an example embodiment;

FIG. 7 is a messaging flow diagram of a license VDR of a cleartext gateway computing device at an authentication service, according to an example embodiment;

FIG. 8 is a messaging flow diagram of a VDR of a cleartext gateway computing device at an authentication service and licensing service, according to an example embodiment;

FIG. 9 is a messaging flow diagram of a VDR of a cleartext gateway computing device having existing licenses at an authentication service, according to an example embodiment;

FIG. 10 is a messaging flow diagram of a VDRs managed at a cleartext gateway computing device with an authentication service, according to an example embodiment:

FIG. 11 illustrates a state diagram showing connectivity states of a cleartext gateway computing device, in an example embodiment;

FIG. 12 illustrates a network topology incorporating a cleartext gateway device and allowing communication between cleartext endpoints and endpoints included in a secured enterprise network, according to an example embodiment;

FIG. 13 illustrates an example computing system in which aspects of the present disclosure can be implemented;

FIG. 14 illustrates an example virtualization environment implemented on a computing system, illustrating a mechanism by which private-domain and cloud-based virtual machines can be implemented; and

FIG. 15 illustrates an example multi-user computing arrangement illustrating shared computing resources across different partitions and/or virtual machines, according to example embodiments.

### DETAILED DESCRIPTION

As briefly described above, embodiments of the present invention are directed to methods and systems for providing a cleartext gateway system allowing cleartext access between computing systems wishing to connect to a secured enterprise, for example from a secure cloud-based system or a remote, secured, and trusted computing system that does not require a separate secured connection (e.g., VPN) as an additional layer of communication security to the overall system. Such arrangements as discussed herein provide flexibility to allow trusted devices external to a secured enterprise to connect to portions of the enterprise that trust those endpoints. In some embodiments, such devices that are not part of the enterprise are referred to herein as “cleartext endpoints” since they refer to endpoints that connect to a gateway to access internal resources of a secured enterprise network, but do not require a separate securing of the connection between those devices and the gateway, for example by VPN. Accordingly, the methods and systems of the present disclosure provide uniform security across public and private domain portions of an organization's network, simplifying administration of an overall network and improving flexibility regarding data storage, license allocation, and computing resource allocation.

According to example embodiments discussed herein, endpoints can include computing systems and virtual machines in a secured enterprise network that may be isolated by encrypting transmissions between those systems with keys possessed only by an intended recipient. Within a network, the virtual machines may be logically organized into a number of community-of-interest (COI) groups. Each COI may use an encryption key to secure communications within the COI, such that only other endpoints in the COI may decrypt the message. Endpoints may be automatically provisioned with configuration information, such as the encryption keys, when the endpoint joins the secured network, e.g., when a virtual machine is started. The provisioning information may be created based on a template stored on a configuration server. As noted in the above-cited patents and patent applications, use of the COI groups, and associated authentication, allows for complete opacity of a network for devices not belonging to a COI group, allowing a secured enterprise network to appear to have different computing system endpoints therewithin based on the COI to which that endpoint or device belongs.

In the context of the present disclosure, the cleartext gateway establishes virtual device routers that are dedicated to each endpoint not included in the secured enterprise. Such virtual device routers can be dedicated to specific endpoints, acting as a proxy for that endpoint from the perspective of devices in the secured enterprise network. Such proxying allows for connection of cleartext endpoints that lack capability natively to connect to a Stealth network to connect to that network via a router component, with individual virtual data relays associated with each such endpoint. Furthermore, the cleartext gateway of the present disclosure allows for direct addressing of such cleartext endpoints via the native IP addressing of those endpoints themselves, via the cleartext gateway (e.g., without requiring addressing to the gateway itself).

According to example embodiments discussed herein, endpoints, such as virtual machines, in a network may be isolated by encrypting transmissions between the endpoints with keys possessed only by an intended recipient. Within a network, the endpoints may be logically organized into a number of community-of-interest (COI) groups. Each COI may use an encryption key to secure communications within the COT, such that only other virtual machines in the COI may decrypt the message. Virtual machines operating as endpoints may be automatically provisioned with configuration information, such as the encryption keys, when the virtual machine is started. The provisioning information may be created based on a template stored on a configuration server.

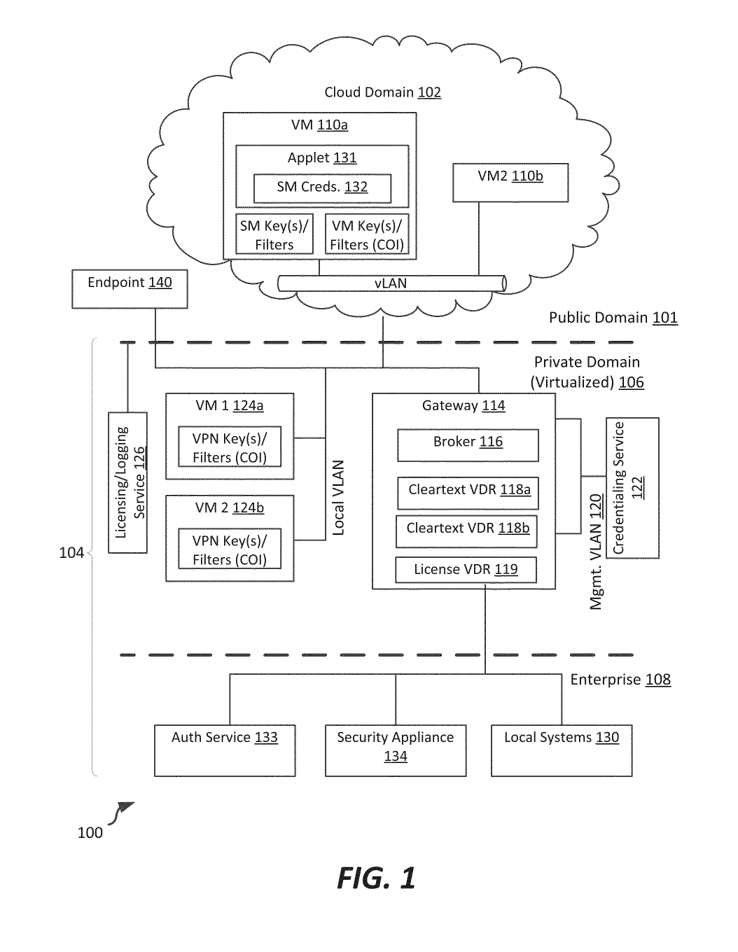

In particular embodiments, the present disclosure relates to a cleartext gateway computing device useable in connection with a secured enterprise network implementing Stealth technology provided by Unisys Corporation of Blue Bell, Pa. The cleartext gateway allows connection to the secure enterprise network by trusted external endpoints, such as mobile devices or cloud devices implementing specific trusted software with which a separate VPN connection to a gateway may not be required. Rather, the external endpoint itself may manage security by connecting to the gateway via a dedicated connection, or by being located within a trusted network. Example arrangements in which a cleartext gateway may be used are illustrated in connection with FIG. 1, below.

Referring now to FIG. 1, an example architecture 100 in which aspects of the present disclosure can be implemented is illustrated. The architecture 100 represents a schematic arrangement useable to establish a connection to a computing architecture external to a private domain. The architecture 100 as shown includes computing systems, such as physical and virtual machines, established in both a private domain (e.g., managed within an organization) and in a public domain, for example either as stand-alone computing systems connected to the private domain via the Internet, or a cloud-based domain (e.g., on computing systems that are managed from a public domain or third-party network). Although in some embodiments such an arrangement may require use of a secured connection between the external and cloud-based endpoints, it may in some cases be advisable to use a cleartext (unencrypted) connection to the secure enterprise network in other cases, examples of which are discussed herein.

In the embodiment shown, the architecture 100 includes an external environment 101, including cloud domain 102, and a private domain 104. The private domain 104 can include both a virtualized component 106, and an enterprise support component 108. Generally, the architecture represents computing resources available to an enterprise for managing, for example, computing or storage tasks.

In the embodiment shown, the cloud domain 102 includes a plurality of configurable cloud-based virtual machines 110 (shown as virtual machines, or VMs, 110a-b). The cloud-based virtual machines 110 can be configured for use in connection with a common virtual network, or vLAN 112, that allows the cloud-based VMs 110 to intercommunicate. The vLAN 112 is communicatively connected to the private domain, for example via a gateway device 114, as discussed below, for communication with locally-managed virtual machines within the private domain 104. Although in the present disclosure two cloud-based VMs 110a-b are shown, it is noted that other virtual machines, and associated in two or more vLAN arrangements, could be used as well.

In addition, in the embodiment shown, the external environment 101 can include one or more other types of endpoints, e.g., endpoint 140, that are not included within the devices specifically managed within the private domain 104, but intended to be trusted by endpoints within the private domain 104. Such devices can include, for example devices hosting or communicatively connected to a Stealth Secure Virtual Terminal (“SSVT”) device, provided by Unisys Corporation of Blue Bell, Pa. Example operation of such a device is described in a number of applications, including: U.S. Provisional Patent Application No. 61/389,511, filed Oct. 4, 2010, and entitled “System and Method for Providing a USB Stick-Based Thin Client”, Attorney Docket No. TN521.P, the disclosure of which is hereby incorporated by reference in its entirety; U.S. Provisional Patent Application No. 61/389,535, filed Oct. 4, 2010, and entitled “System and Method for Providing a Stealth Secure Virtual Terminal”, Attorney Docket No. TN533.P, the disclosure of which is hereby incorporated by reference in its entirety; and U.S. patent application Ser. No. 11/714,598, filed Mar. 6, 2007, entitled “Gateway for Securing Data to/from a Private Network”, Attorney Docket No. TN400.US-CIP3, the disclosure of which is hereby incorporated by reference in its entirety. Accordingly, communication with such devices, since secured using Stealth-based communications and pre-configured with licensing connection information, does not require a secure connection for communication with a gateway, particularly when positioned within and communicating from within an enterprise network. In such instances, a secured, e.g., VPN-based connection is not available, so a cleartext-based connection is used, accordingly to example embodiments of the present disclosure. Accordingly, for such connections, rather than connecting to a gateway device that implements VDRs (discussed in further detail below) providing a secured VPN-based interface, a cleartext gateway device is provided herein that implements a cleartext interface by which such devices can connect to trusted devices within the private domain 104.

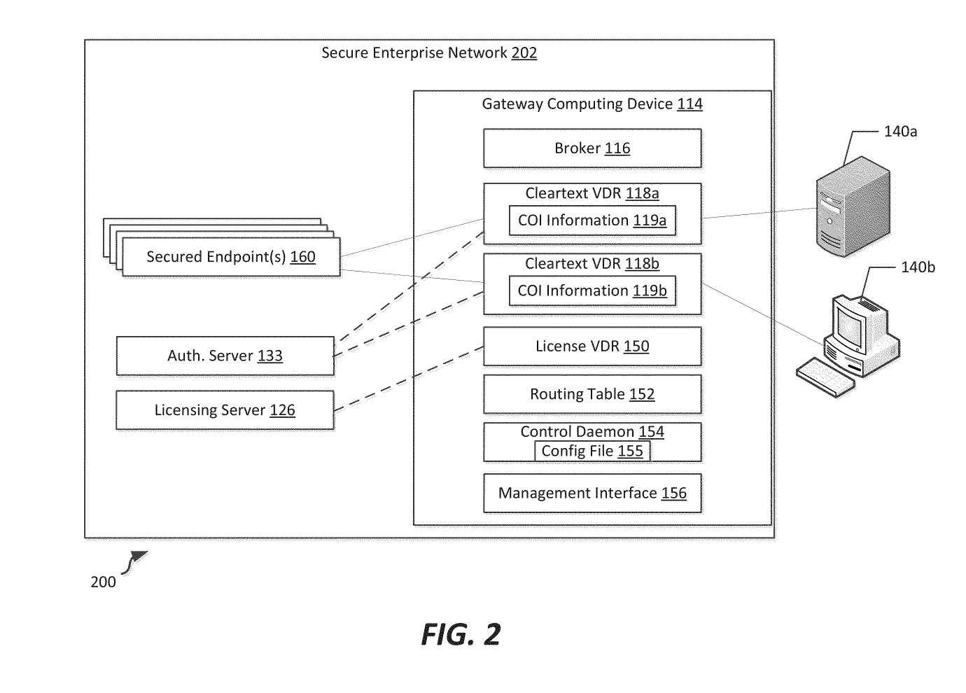

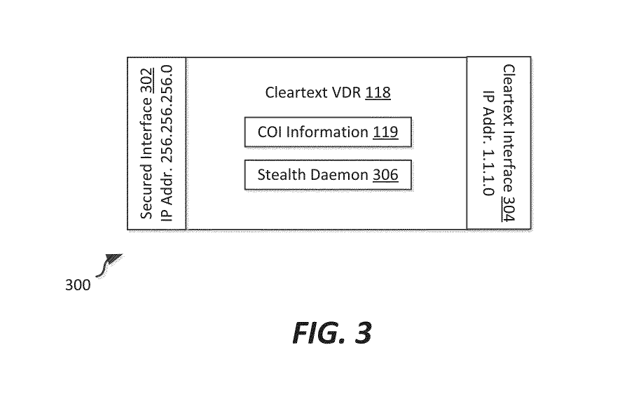

In private domain 104, a gateway device 114 provides a communication location for external endpoints, such as endpoint 140 or cloud-based VMs 110, to coordinate communication with private domain systems. The broker 116, included within gateway device 114 in the embodiment shown, can be used to establish secure communications with such public domain endpoints, for example by instantiating and managing virtual data relay devices, also known as virtual device routers, or VDRs 118, that manage private-domain community of interest keys and filters for such external endpoints while maintaining a dedicated connection to those external endpoints, including endpoint 140 and cloud-based VMs 110. As noted below, use of such VDRs 118 can include, for example, a Stealth-based interface that uses private-domain community of interest keys and filters, also referred to herein as VPN COI keys and filters, for communication with private domain VMs, while providing a cleartext interface via the gateway device 114 to a cloud-based VM 110 for communication over the internet. Details regarding a cleartext implementation of the gateway device 114 and associated broker 116 are discussed in further detail below in connection with FIGS. 2-3.

When initially installed, the gateway device 114 and broker 116 can be configured to provide cleartext communications to an external endpoint, as well as Stealth-based secure communications with other private domain systems. The broker 116 should be configured with appropriate Stealth-based credentials, as well as the service community of interest and filters to be used, as well as details regarding that cloud broker's connection useable to establish the cleartext connection. Other configuration features can be initialized and set prior to addition of external endpoints as noted herein.

In addition, in the embodiment shown, a credentialing service 122 can be provided that connects to the gateway device 114 and the broker 116 via a management vLAN 120. The credentialing service 122 can be implemented as a separate virtual machine or service, and generates and provides credentials for use across the external environment 101 including within the cloud domain 102, such that credentials need not be stored at each VM when that VM is created; rather, credentials for VMs can be retrieved on demand, for example based on requests received at the gateway device 114. Using the credentialing service 122, credentials specific to their purpose are provided at boot time, used immediately to authenticate a VM and authorize its COIs, and then the credentials are discarded. Use and discarding of credentials after authentication prevents replay attacks, duplicating VMs, and RAM/VM scraping for credentials.

In addition, within the private domain 104, a plurality of private domain virtual machines 124 (shown as VMs 124a-b) can be maintained. These VMs 124 can be within the same or different COIs to each other and to the cloud-based VMs 110 and/or external endpoints 140. A licensing service 126 can be implemented within the private domain 104 as well, to provide management functions associated with the various cloud-based VMs 110, 124 or other endpoints (e.g., endpoint 140) created within or managed by the overall arrangement. The licensing service 126 can be implemented on a licensing server, and can provide license issuance, tracking, and logging of license requests within the Stealth network.

In some embodiments, the enterprise support component 108 can include systems used to provide security to computing systems, including both virtual systems and physical systems, within the enterprise. In particular, the enterprise support component 108 can include a plurality of local systems 130 (e.g., hardware or virtual systems) as well as Stealth-enabling systems including an authentication service 133 and a security appliance 134. The authentication service 133 maintains and distributes community of interest keys in response to receipt of credentials in a request (as have previously been retrieved by a hardware or virtualized system from the credentialing service 122). The authentication service 133 can also maintain and distribute filters for use in connection with such community of interest keys for controlling communicative access among systems in the architecture 100. In example embodiments, the authentication service 133 corresponds to a Stealth authentication service that can be used to authorize each Stealth-based (secured) endpoint within an enterprise, as well as via cloud-based VMs 110, cleartext endpoints such as endpoint 140 connected via the cloud domain 102, and VDRs 118 used to communicate with such cloud-based VMs and other devices in the cloud domain 102.

Using the authentication service 133, cloud-based VMs 110, as well as other external endpoints (e.g., endpoint 140), are authenticated and authorized. In the context of a secured connection to an external endpoint, a first authorization is to authenticate the IPsec VPN connection and authorize the corresponding VDR's COIs, providing the VDR 118 that is associated with each particular VM 110 with COI keys and filters. However, a second authentication is to authenticate a logon service of the VM 110, and authorize cloud-based COIs for use within the cloud. This second authentication is performed in the case of a cleartext connection to the secure enterprise network as well, despite the first authorization being avoided (with COI keys and filters being obtained by an authorized device having received previously an authentication key and access address information). For example, the logon service can be authenticated using an Active Directory instance or via an authentication performed from the enterprise domain.

It is noted that the authentication service 133 may need to include particular settings to accommodate a cleartext gateway computing device, such as gateway device 114, in some embodiments. For example, in some cases, the authentication service 133 may be configured to validate individual VDR traffic from VDRs 118 at the gateway device 114, or multiple devices 114 may be included in a network. Accordingly, an XML file can designate a particular authorization group and can be loaded at respective gateway devices 114 to associate those devices with a particular authentication service 133.

In the embodiment shown, the security appliance 134 can be used as a secured endpoint to which other non-secured computing systems or enterprise resources can be connected (e.g., SAN systems, or other storage). In example embodiments, the security appliance 134 could alternatively be used as the licensing service 126. In still other embodiments, the security appliance 134 can be removed altogether (e.g., in entirely IPsec-based implementations).

Referring back to the cloud-based VMs 110, in the embodiment shown, a cloud-based VM can include an applet 131 that stores service mode credentials 132 useable to initiate authentication of the cloud-based VM 110. Additionally, the service mode credentials 132 can be used to obtain service mode keys and/or filters useable to access the authentication service 133, and thereby obtain virtual machine keys and filters that associate the VM with a particular community of interest. Similarly, for other types of devices, service mode credentials 132 can be provided to such devices, for example using a hard-coded SSVT device, as noted above. In example embodiments, credentialing of VMs 110 or endpoint 140 can be accomplished via the applet 131.

Referring to FIG. 1 overall, it is noted that although the present disclosure relates to methods of integrating cloud-based virtual machines and external endpoints into a private virtualization environment, it is noted that in initializing the architecture 100 of FIG. 1, particular security features should be initialized prior to adding cloud-based VMs, such as VMs 110, to such an arrangement. For example, communities of interest, filter sets, and roles are typically created in the authentication service 133 for such external endpoints. Furthermore, one or more security groups corresponding to the roles intended to be assigned to a particular endpoint should be created, for example in Active Directory. User members of a security group should also be defined.

Furthermore, and still referring to FIG. 1, particular features of the architecture 100 itself should be installed prior to addition of cloud-based VMs or other external endpoints. For example, the security appliance 134, as well as the licensing service 126 should be initialized and configured to be assigned an internet-routable IP address (or addresses, if multiple such systems are deployed) and particular communities of interest, such as an administrator COI, a service COI, and a license COI should be defined alongside associated filters. For example, an administrative service filter may allow access to any VM within the arrangement, while a license filter that is distributed to a remote system should limit access by that system using the licensing COI to communications with the licensing and logging server, despite the fact that each of the other VMs will also be members of that COI for the licensing/logging requirements associated with those other VMs. Additionally, a security installation package (e.g., to administer Stealth within each VM to be instantiated) is prepared for inclusion in each VM, and for each OS hosted within a VM.

Referring now to FIGS. 2-3, a specific implementation of a gateway device 114 is disclosed in which the gateway device provides a cleartext interface that can provide dedicated, cleartext connections to endpoints that are not explicitly included within a private domain 104. Such endpoints can include, for example, external endpoints 140, which may be mobile devices or other devices that a user may wish to use in connecting to the private domain either from external to the private domain or from within a secure enterprise network. In such cases, because VPN connection is not required (or even possible in the event of connection of the endpoint 140 within a secured enterprise network) a cleartext gateway computing system provides a proxying service by which the cleartext gateway manages routing and visibility of endpoints within the private domain on behalf of the external endpoint.

FIG. 2 illustrates an example architecture 200 including a cleartext gateway computing device, such as gateway device 114 in the context of a secure enterprise network 202. In general, the cleartext gateway computing device 114 operates as a layer 3 forwarding device which performs a proxying function between cleartext endpoints 140a-b and secured endpoints 160. The proxying function operates transparently in such a way that the systems in the secure enterprise network communicate with the same IP address as configured on the cleartext endpoint. The packet path between the secured endpoints and the cleartext endpoints must pass through the cleartext gateway computing device 114 as a routing hop, bidirectionally. Generally, the cleartext network is a subnet in which the addresses of the proxied cleartext endpoint systems reside, while the secured network corresponds to one or more subnets in which the secured endpoints 160 reside.

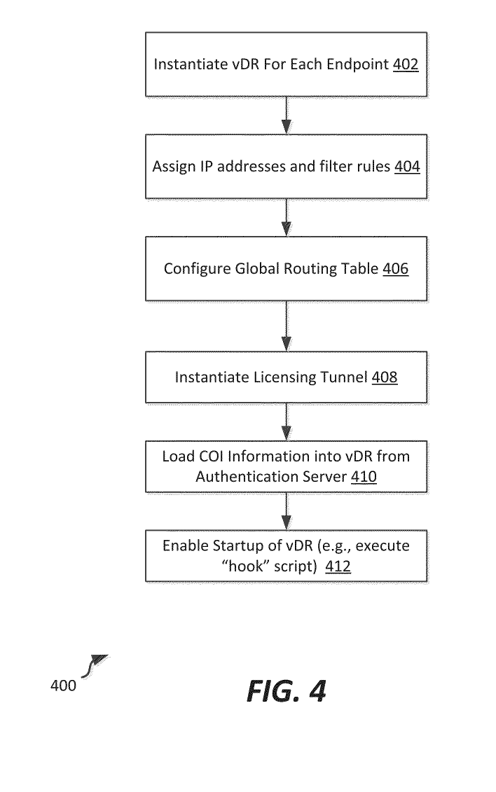

In the embodiment shown, the cleartext gateway computing device 114 includes a broker 116, as well as a plurality of cleartext VDRs 118a-b. The broker 116 corresponds to a service useable to manage the cleartext VDRs 118a-b, including creation of such VDRs for use with cleartext endpoints 140a-b. Each of the cleartext VDRs 118a-b is instantiated such that it is dedicated to an associated cleartext endpoint 140a-b. Such cleartext endpoints include associated COI information 119a-b which corresponds to the COIs associated with the users of the cleartext endpoints 140a-b. Accordingly, even though a cleartext connection is established between corresponding VDRs 118a-b and respective cleartext endpoints 140a-b, the COI information 119a-b, respectively expose only particular secured endpoints 160 (e.g., VMs or physical computing systems) within the secure enterprise network 202. The COI information 119a-b is retrieved from the authentication service 133 during authentication of the cleartext endpoint to the cleartext gateway computing device 114, as noted below in conjunction with FIGS. 4-6.

In the embodiment shown, the cleartext gateway computing device 114 further includes a license VDR 150 which maintains a license connection to licensing service 126. The license VDR 150 maintains this connection to validate the operation of the cleartext gateway computing device 114; as explained below, upon disconnection of the license VDR 150 from the licensing service 126, the broker 116 halts operation of each of the cleartext VDRs 118a-b until communication with the licensing service 126 can be reestablished.

A routing table 152 is established in the cleartext gateway computing device 114, and is used for routing traffic exchange to and from secured endpoints 160 from the cleartext endpoints 140a-b via VDRs 118a-b. For example, the routing table 152 maintains network addresses of the cleartext endpoints 140a-b, as well as for secured endpoints 160. Additionally, the routing table 152 manages IP addresses for each of the VDRs 118a-b; in example embodiments, each VDR manages an IP address for an internal, or secured, interface, as well as an external, cleartext interface, as illustrated in FIG. 3. The routing table information can then be used to determine routing of data from the secured endpoints to the cleartext endpoints 140 by ensuring such routing occurs through the cleartext gateway computing device 114. Similarly, the VDRs map traffic received from cleartext endpoints 140 to particular secured endpoints that are members of a common community of interest, based on community of interest information 119 associated with the cleartext endpoint by way of the associated VDR 118.

In accordance with example embodiments of the present disclosure, each VDR 118 is assigned a number of attributes for use within the secure enterprise network 202. Such attributes include, for example, a unique name and network namespace, a virtualized network interface assigned to the cleartext network, a virtualized network interface assigned to the secured enterprise network, a protocol daemon configured to implement Stealth-based protocols, such as MLSTP, a set of communities of interest, an IP address presented to endpoints in the secured enterprise network, an IP address used as routing hop to the cleartext network, and one or more policy routing rules.

A control daemon 154 manages the run-time configuration of the network interfaces, the VDRs, IP policy-based routing table 152, and forwarding rules required to map traffic between a cleartext endpoint 140 and secured endpoints 160 for authorized COIs. It also provides an administrative interface for management of the cleartext gateway computing device 114. The administrative interface can be, in some embodiments, a command line interface by which an administrative user can inquire into the status of VDRs 118 within the cleartext gateway computing device 114 as well as license VDR 150, e.g., by administrative command. An administrative user can also, for example, start, stop, reload, or rollback particular VDR configurations, as well as to show interfaces for each VDR and the status of such interfaces. In some instances, the control daemon 154 may perform SSH or other authentication services, may manage system logs using a syslog API, set firewall rules using packet filters, or can set a Net-SNMP agent to provide read-only access to certain system configuration and/or performance data. Other operations may be available as well, in alternative embodiments.

In example embodiments, the control daemon 154 includes a plurality of subordinate threads which assist in governing operation of the cleartext gateway computing system 114. Such threads can assist by, for example, executing commands from a configuration file at startup, creating VDR data paths via the routing tables 152, or initializing secured packet processing (e.g., using Stealth secured communications technologies, provided by Unisys Corporation of Blue Bell, Pa.) for each VDR by obtaining COI material and filter rules from the authentication service 133 for that VDR. In addition, the control daemon 154 can be configured to handle configuration and management commands received via the management interface 156, which provides a terminal or automated arrangement. The control daemon 154 can maintain the license tunnel.

In some instances, the cleartext gateway computing device 114 includes a provisioning utility installed thereon that delivers endpoint software useable within a Stealth-enabled network, allowing the gateway device 114 to operate within the secured enterprise network, such as specific registry and networking settings to be used. The provisioning utility may also allocate, for the cleartext gateway computing device 114 Stealth-based security credentials for VDRs that may be instantiated at the cleartext gateway computing device 114.

In addition to the above, the cleartext gateway computing device 114 can be configured to perform one or more logging or management operations via management interface 156. For example, a dump utility could be included to assemble configuration, logs, and other feedback into a single file to be used for system troubleshooting. Additionally, an enterprise management agent could be used to monitor operational statistics of the cleartext gateway computing device 114, for example to provide to a management server within the secure enterprise network. Finally, one or more scripts may be included as well, which can be executed during particular events, such as system startup, shutdown, VDR configuration, or other events.

In operation, the cleartext gateway computing device 114 makes data forwarding decisions based on values in the packet, rather than only the destination address. For example, the kernel provides an ordered set of rules containing matching criteria which are evaluated to determine the routing table to employ for the frame. Using this mechanism the next hop for a packet can be based on the source address of the frame, and this feature is used by the cleartext gateway computing device 114 to relay frames for a given cleartext endpoint 140 through a particular VDR 118.

Overall, the cleartext gateway computing device 114 maintains a configuration status in a tree structure in memory, for example a tree structure can be managed that includes various data types, such as strings (useable for naming), IP addresses, route definitions, integers, or other features, and can be used to define specific paths. Example paths managed in a configuration tree structure can include: a configuration version, a hostname of the cleartext gateway computing device 114, logging options, authentication methods (e.g., LDAP, NTLM, none, etc.), bindings used to communicate with an authentication server, a list if network interfaces or interface names, text labels for such interfaces, IP addresses assigned to each namespace, virtual interfaces and mappings to physical interfaces, a physical interface definition, virtual LANs managed at the cleartext gateway computing device 114, a license VDR, an address of a secure interface, directories in which license VDR provisioning files exist and other settings for a license VDR (e.g., destination addresses), IP address pools and pool ranges, and routing table entries associated with various namespaces. In addition, global routes, system logging settings (options and names), availability/clustering parameters and names, and cleartext mappings between VDRs and cleartext endpoints (e.g., including cleartext maps, lists of cleartext hosts, etc.) can be tracked. Other options are possible as well.

FIG. 3 illustrates an example virtual data relay arrangement 300 including VDR 118. The VDR 118 is instantiable within a cleartext gateway computing device 114 to establish a cleartext connection to an endpoint not resident within the secure enterprise network, such as network 202. As illustrated in FIG. 3, a VDR 118 contains COI information 119 associated with the cleartext endpoint 140, and also includes virtualized interfaces directed toward the cleartext endpoint 140 and toward a secure enterprise network and associated secured endpoints 160, accordingly. Specifically, the VDR 118, in the embodiment shown, includes a secure interface 302 and a cleartext interface 304. Each of the secure interface 302 and cleartext interface 304 are assigned different IP addresses, to allow the interfaces to operate as noted above, allowing the broker 116 to manage traffic based on the endpoint from which data is received and to be sent to, using routing tables managed in the cleartext gateway computing device 114.

In example embodiments, each cleartext endpoint 140 and associated VDR 118 forming a clear text subnet will include an IP address for the cleartext gateway computing device 114, as well as additional IP addresses for each cleartext interface 304, and an IP address for internal routing. Accordingly, in an example configuration including ten cleartext endpoints on one subnet that should participate in the secured enterprise network, a cleartext subnet will include twelve IP addresses.

In example embodiments, a daemon 306 is instantiated as part of the VDR 118, and controls communication via the secure interface. In example embodiments, the daemon 306 is a “Stealth” daemon configured to implement Stealth-based communications, and can process traffic for a dedicated cleartext endpoint via the secure interface 302 from the VDR.

Referring to FIGS. 2-3 generally, it is noted that the cleartext gateway computing device 114 assigns various namespaces for management of data routing among endpoints, including network namespaces, a global namespace, and VDR namespaces. Regarding network namespaces, the cleartext gateway computing device 114 provides the capability to assign separate network namespaces to a process tree. A network namespace is logically another copy of the network stack which contains its own interfaces, route tables, policy rules, and firewall rules. The cleartext gateway computing device 114 makes use of multiple network namespaces to route traffic between the secured network and cleartext network. The global namespace represents a default namespace including the secure interface 302, an “intra” interface defining VDR routings, and the cleartext interface 304. Two bridge devices are also allocated and used as a path to the VDR namespaces.

In example embodiments, two or more VDR namespaces are used to isolate daemons 306 associated with VDRs, which are allocated to process traffic for individual cleartext systems, and for the license VDR 150 (which may also have a corresponding daemon, not shown). Within each VDR namespace is a secured interface, an “intra” interface, and a virtual “tap” adapter created by the control daemon 154. The secured interface is used for Stealth-related packet I/O.

Referring now to FIGS. 4-6, example methods by which a cleartext gateway computing device 114 can be instantiated and operated are disclosed, according to example embodiments. FIG. 4 is a flowchart of a method 400 for instantiating virtual data relays in a cleartext gateway computing device, according to an example embodiment of the present disclosure. The method 400 includes instantiating the device (step 402), such as by initializing VDRs 118, for each cleartext endpoint (e.g., cleartext endpoints 140) for which a connection to a secure enterprise network is to be made. Instantiating the VDR can include a variety of operations; for example, in some embodiments, an instantiation operation includes forming a daemon useable and associated with the VDR, and processing configuration parameters associated with the VDR. In such embodiments, a startup configuration can be loaded from a file.

In the embodiment shown, for each VDR included at the cleartext gateway computing device 114, IP addresses are assigned to a secure interface and a cleartext interface portion of the VDR (step 404). For example, in some embodiments bridge devices are instantiated, including the secure bridge device and “intra” bridge device included in the VDR and which define the routing to the secure enterprise network and through the VDR between cleartext and secure interfaces, respectively. In such cases, each bridge device is assigned an IP address. For each address, a communication associated with the associated interface can be transmitted from that interface (e.g., an ARP) to update the L2 neighbor cache of systems on the network to which that interface is oriented. Received replies indicate that another system already has the address to be assigned to the interface. Assuming no replies are received, the cleartext interface 304 and secure interface 302 of the associated VDR are assigned IP addresses.

In the embodiment shown, a global routing table is created (step 406), and a license tunnel is established (step 408). The license tunnel creation may include, for example, creation of a license VDR, initiation of a secure daemon, and loading of locally-stored COI key material used by the license VDR to establish the license tunnel.

Once the license tunnel is established, the cleartext gateway computing device 114 is authorized to communicate with the authentication service 133. Accordingly, in such embodiments, the cleartext gateway computing device 114 can connect to the authentication service 133 to obtain community of interest information (e.g., COI keys and filters associated with the user of the cleartext endpoint with which the VDR is used). Once the COI information is loaded in the respective VDR (e.g., into a secure daemon associated with the VDR), the cleartext gateway computing device 114 can determine whether the license tunnel remains established. The VDR will apply filter rules based on the received COI information, and the VDR will be set to a “pending license” state.

The method 400 accordingly includes loading COI information (e.g., keys and filter rules) associated with each example COI into the corresponding VDR. For example, if a first VDR is associated with a cleartext endpoint 140 intended to have access to computing systems or other endpoints within COI A of the secure enterprise network, and a second VDR is associated with a different cleartext endpoint 140 intended to have access to computing systems or other endpoints within COI B of the secure enterprise network, each VDR will obtain COI keys and filter lists associated with that COI and endpoint, respectively, and apply those at the first and second VDRs. Accordingly, a first cleartext endpoint will access only endpoints within COI A through an associated VDR, while a second cleartext endpoint will access only endpoints within COI B through a different associated VDR.

In example embodiments, once license and COI information is loaded and initialized, startup of the VDR can then be triggered (step 410), for example by execution of a “hook script”. Such hook scripts allow an arbitrary program to be executed at stages during the execution process of the control daemon 154. They can be used to add arbitrary routes or filter rules. In some embodiments, a hook script is stored at the cleartext gateway computing device 114, and is passed some amount of system configuration information via standard input. Hooks may provide context-specific configuration information. For example, a hook called during the interface configuration stage may be provided the name of the interface which is being configured. If a hook script exists in the designated path, and is executable, it will be called. Example hook scripts executable by the cleartext gateway computing device 114 include a startup hook script, which initiates startup of the cleartext gateway computing device 114, a shutdown hook script which terminates operation of the cleartext gateway computing device 114, or an interface up hook script, which receives an identification of an interface and enables that interface.

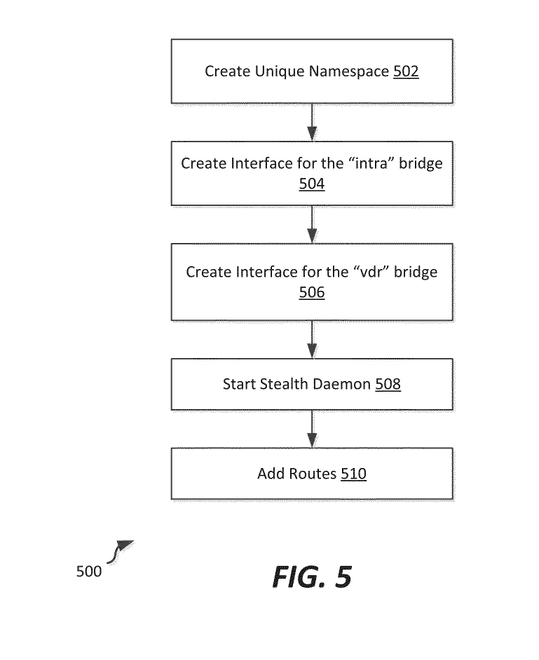

FIG. 5 is a flowchart of a method 500 for configuring networking settings for a virtual data relay within a cleartext gateway computing device, according to an example embodiment. The method 500 can be performed, for example, as part of instantiating VDRs for a cleartext gateway computing device 114, such as is illustrated as part of method 400 above (e.g., at steps 402-404). In the embodiment shown, the method 500 includes instantiating a VDR for each cleartext endpoint for which communication with a secure enterprise network is desired (step 502). In example embodiments, this can include creating a unique network namespace in the configuration tree of the cleartext gateway computing device 114 for the VDR based on a supplied VDR number. Generally, each cleartext gateway computing device 114 can be mapped to multiple VLAN arrangements. When defining a namespace, each VLAN will be associated with a “vdrset” namespace that can include one or more VDRs 118 assigned thereto. When naming or associating a VDR 118 to a particular namespace, the name can be, for example, a concatenation of the string “vdr”, the “vdrset” name, and the VDR number. For example, names could include “vdr-vdrset1-1”, “vdr-vdrset2-1”, etc. The IP addresses assigned to the VDRs 118 will be drawn from the address pool assigned to a vdrset of which that VDR is a member.

In the embodiment shown, the method 500 can further include creating an interface for the “intra” bridge of the VDR (step 504). In example implementations, one end is named “intra-in” and the other is named as the concatenation of the string “intra”, the “vdrset” name, and the VDR number. For example, “intra-vdrset1-1”. In such cases, the “intra-in” interface is assigned to the network namespace for this VDR, while the other half of the veth is assigned to the “intra” bridge.

In the embodiment shown, the method 500 can also include creating an interface for the VDR bridge (step 504), which maps secured endpoints to a particular VDR. In an example implementation, one end is named “secured-in” and the other is named as the concatenation of the string “secured”, the “vdrset” name, and the VDR number. For example, “secured-vdrset1-1”. In such cases, the “secured-in” interface is assigned to the network namespace for this VDR, while the other half is assigned to a “secured” bridge.

A daemon, such as daemon 306 of FIG. 3, is started (step 506), and routes are added by way of routing tables (step 508). Once routes are added, traffic can be managed by the daemon 306 among the interfaces as defined previously. Accordingly, the VDR is therefore configured to manage traffic for a particular cleartext endpoint.

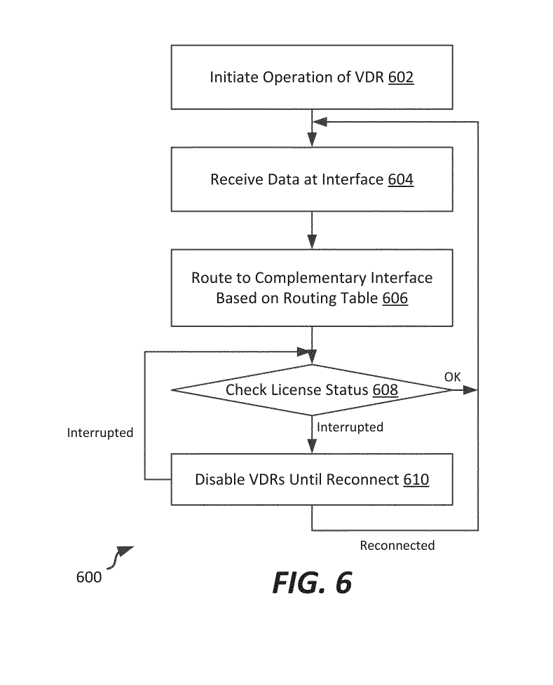

Referring now to FIG. 6, a flowchart of a method 600 for communicating with an external endpoint from a secure enterprise network, according to an example embodiment. The method 600 represents general data traffic exchange across a cleartext gateway computing device 114 between a cleartext endpoint and one or more secured endpoints within a common community of interest as that cleartext endpoint.

In the embodiment shown, the method 600 includes initiation of a VDR (e.g., VDR 118) for use in connection between such endpoints (step 602), such as endpoints 140, 160. This can be accomplished, for example, using the methods described above in connection with FIGS. 4-5. Once the VDR is established, data is received at an interface (step 604). This can include receiving data at a cleartext interface 304 from a cleartext endpoint 160, or receiving data at a secure interface 302 from a secured endpoint 160, e.g., an endpoint within a Stealth-enabled secure enterprise network.

In the embodiment shown, the method 600 includes routing the data to a complementary interface (step 606), for example via use of routing tables that define a routing between endpoints. For example, routing of data from a cleartext endpoint may require review of a routing definition between that endpoint and one or more endpoints within the secure enterprise network, as well as use of COI information (keys and filters) to determine the secured endpoints that are accessible to and visible to that cleartext endpoint. Similarly, routing of data from a secured endpoint to a desired cleartext endpoint requires routing that data to the cleartext gateway computing device 114, which in turn determines, based on the intended endpoint (as noted based on addresses in the routing tables managed at that system) the intended cleartext endpoint; accordingly, an appropriate VDR is employed to communicate such data to the cleartext endpoint. In some scenarios, data addressed to a particular IP address assigned to a secure interface 302 of a VDR 118 results in forwarding of that data to the cleartext endpoint associated with that VDR.

In addition to routing of data, during operation of the cleartext gateway computing device 114, maintenance of a licensing tunnel is monitored. In the example shown, a license status is monitored to determine whether a licensing tunnel is maintained open (step 608). This license polling may occur periodically, e.g., every 30 seconds. If the licensing tunnel remains open (branching OK), continued data exchange is allowed among endpoints 140, 160. However, if the license tunnel has been closed for a period of more than a predetermined number of polling operations or minutes (branching Interrupted as shown in FIG. 6), each of the non-license VDRs established at the cleartext gateway computing device 114 are disabled and a reconnection process is triggered (step 610). During the reconnection process, polling of the license VDR for an active license tunnel can occur more frequently, e.g., every 5 seconds, and a polling operation (step 608) can repeat. Once reconnection occurs, data exchange is again allowed by VDRs.

It is noted that because the cleartext gateway computing device 114 requires a separate VDR for each cleartext endpoint 140, it may be advisable to employ more than one such cleartext gateway computing device 114, depending upon the number of cleartext endpoints to be accommodated. In such examples, a clustering arrangement can be employed in which a clustering service monitors across a common set of networked cleartext gateway computing devices 114. The clustering service can be managed on each of the devices, and is aware of the configuration of each device for data forwarding/management. The clustering service can manage a cluster management network, separate from the cleartext and secured enterprise networks, ensuring that there is no commingling of cluster-specific network traffic with the secured or cleartext traffic.

In some embodiments, clustering can be automatically started alongside instantiation of a cleartext gateway computing device 114, as part of method 400 of FIG. 4. In such arrangements, a separate clustering daemon can be included as part of the cleartext gateway computing device 114, and can monitor and check status of neighboring cleartext gateway computing devices. In some cases, a pool of IP addresses is reserved for clustered devices, and configurable using the administration tools exposed by the management interface 156.

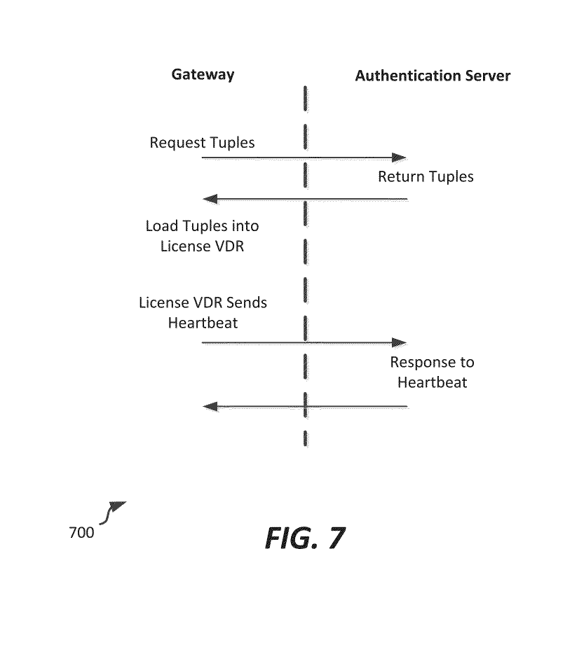

Referring now to FIGS. 7-10, various messaging flow diagrams are illustrated showing connectivity messages being passed among devices, such as the cleartext gateway, an authentication server, and a license server. Such devices can, in embodiments, correspond to the analogous devices of FIGS. 1-3, above.

FIG. 7 is a messaging flow diagram 700 of a license VDR of a cleartext gateway computing device at an authentication service, according to an example embodiment. In the embodiment shown, a cleartext gateway device, such as cleartext gateway device 114 of FIG. 1, transmits a tuples request to an authentication server, such as authentication service 133. The authentication server returns tuples to the gateway, with the tuples corresponding to keys useable to maintain a secure license tunnel open between the license VDR and a licensing server. This can include, for example, key negotiation regarding settings, location, and other information associated with establishing a secure connection between a license VDR at the cleartext gateway device and the licensing server. The returned tuples, which may, in some embodiments, be encrypted with a wrapper key, are decrypted, and loaded into a license VDR at the cleartext gateway device.

Once the license VDR is loaded with such connectivity information, it transmits a heartbeat message to the authentication server, which responds to the heartbeat message. The heartbeat message, and response, ensure continued connection between the authentication server and the cleartext gateway device, and ensures that the license counts tracked by the authentication server remains in sync with the license counts tracked at the cleartext gateway device. It does so by including tags for licenses and a total number of requested licenses in the heartbeat message. An example heartbeat message can appear as follows:

#define AUTH_SVC_SESSION_KEEPALIVE_DOC_TEMPLATE \
“<?xml version=\“1.0\” encoding=\“utf-8\”?>\n\
<session version=\“%s\” sessionID=\“%llu\” numVdrs=\“%d\”
totalVdrs=\“%d\”>\n\
<action>\n\
<keepAlive /\n\
</action>\n\
</session>\n”

If the cleartext gateway device reports a license count that is out of sync with the authentication server, then the authentication server will reply with a rekey command. Accordingly, the response to the heartbeat message by the authentication server will indicate one of a set of possible responses: (1) an indication that the license counts differs between the Auth Service and the SVGW; (2) an indication that the authentication server has shut down the session associated with the cleartext gateway device, (3) an indication of a heartbeat failure between the authentication service and the license VDR, (4) a successful heartbeat response, or (5) an error. If the license count differs, a rekey response is transmitted, and the cleartext gateway device shuts down all running VDRs and restarts VDR authentication. Similarly, an indication that the authentication server has shut down the session will shut down running VDRs. Heartbeat failures, or errors, result in the license state being set to false.

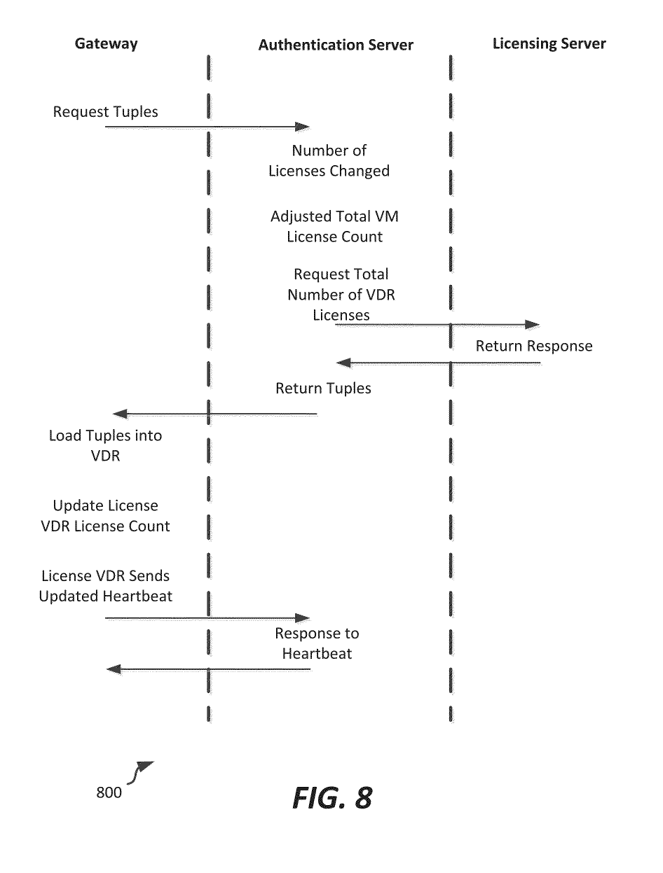

FIG. 8 is a messaging flow diagram 800 of a VDR of a cleartext gateway device at an authentication service and licensing service, according to an example embodiment. In the diagram 800, a tuples request is transmitted from the cleartext gateway device to the authentication server. The tuples request will generally include information received from a remote cleartext endpoint, such as username and password or other authentication information, The authentication server determines whether a number of licenses has changed, and if so, generates an adjusted total number of licenses associated with virtual machines (e.g., endpoints) that are connecting to a Stealth network via the cleartext gateway device.

The authentication server then transmits a request for a total number of VDR licenses to a licensing server, such as licensing service 126 of FIGS. 1-2, above. The licensing server returns a response to the authentication server, which, based on a determination that an adequate number of total number of licenses exist, will generate and return a tuples response to the cleartext gateway device. The tuples response will generally include community of interest information for the particular device seeking to connect via a cleartext connection to a VDR. The cleartext gateway device will then load the tuples information (e.g., the received COI information) into a VDR that is allocated for the particular remote device. The cleartext gateway device will also update a license count associated with the cleartext gateway in the license VDR. Finally, the license VDR will send an updated heartbeat message to the authentication server which will in turn send back a response. The heartbeat message can be as described above in connection with FIG. 7, but with an adjusted number of VDR licenses identified in the heartbeat message. Upon establishing the tuples information within the VDR, and notifying the device connecting to the VDR, that VDR can be used by the remote device to connect to the Stealth network, according to the COI information provided to it. Accordingly, there can be a portion of the Stealth network, partitioned by COI and tied to particular sets of devices, that allows for cleartext communication from remote devices, while still ensuring that the remote devices cannot view (due to perfect forward secrecy) other devices within the Stealth network that are not part of the same cleartext COI.

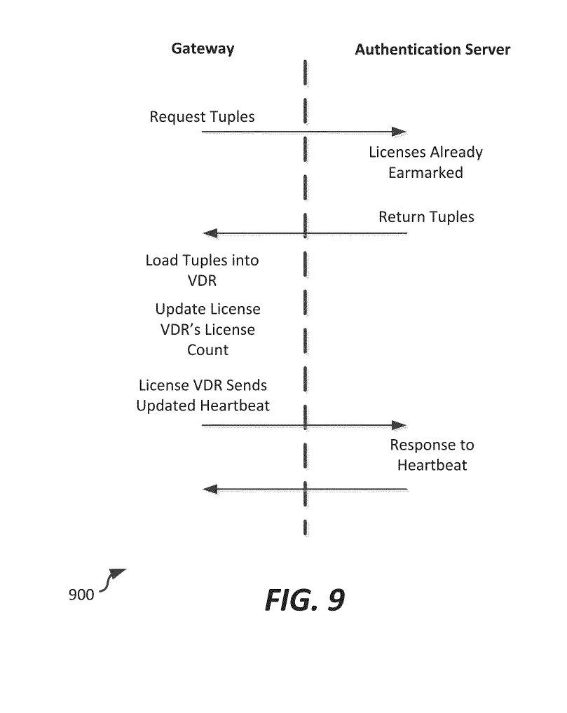

FIG. 9 is a messaging flow diagram 900 of a VDR of a cleartext gateway device having existing licenses at an authentication service, according to an example embodiment. In this example, the cleartext gateway device transmits a tuples request to the authentication server, which determines that a license is already earmarked for the particular VDR. The authentication server returns a tuples response to the cleartext gateway device, which loads the tuples information (e.g., COI keys for the cleartext COI) into a VDR and updates the license VDR's license count. The license VDR then transmits a heartbeat message and receives a response, as discussed above with respect to FIG. 7 (i.e., with unchanged license information, since the license was already allocated to the VDR).

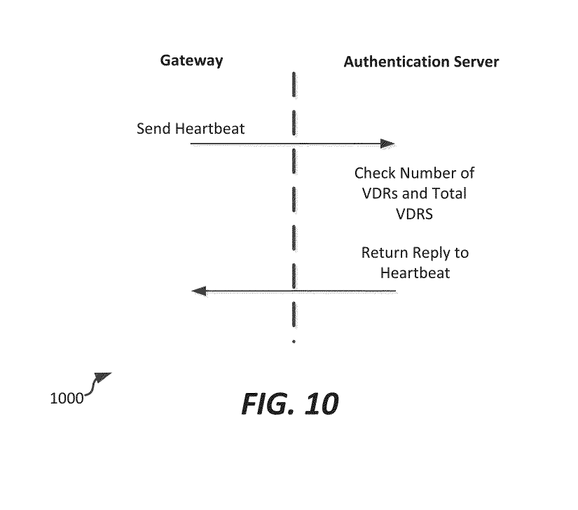

FIG. 10 is a messaging flow diagram 1000 of a VDRs managed at a cleartext gateway device with an authentication server, according to an example embodiment. The messaging flow diagram 1000 occurs, for example, in response to a subsequent heartbeat message of the cleartext gateway device. In the example shown, the cleartext gateway device transmits the heartbeat message, as noted above in FIG. 7; the authentication server checks a total number of VDRs and number of licensed VDRs as identified in the heartbeat message, and generates a responsive message providing status of the licensing of VDRs at the cleartext gateway device, as also noted above. Such a heartbeat message cycle can be performed on a configurable frequency, as set by one or both of the cleartext gateway device and the authentication server when provisioning the cleartext gateway device.

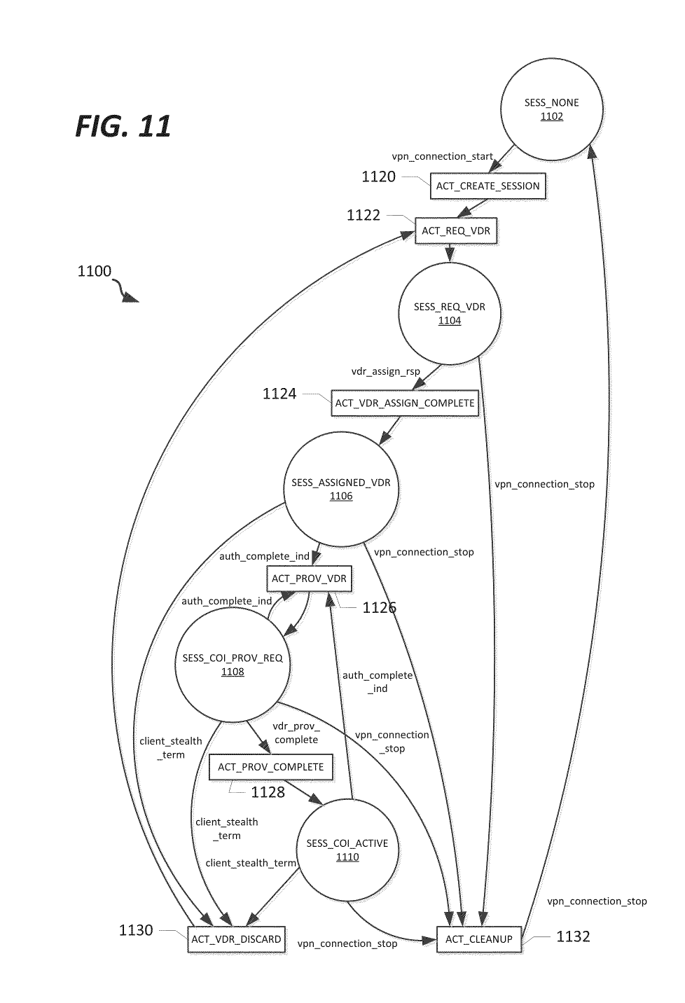

Referring now to FIG. 11, a state diagram 1100 is illustrated showing connectivity states of a cleartext gateway device for a particular enabled network connection between a remote device seeking cleartext connectivity to the Stealth network and one or more secure endpoints included within a secured (Stealth) network. VDR states can include, for example, a null session state 1102 (referred to as SESS_NONE), a VDR request state 1104 (SESS_REQ_VDR), an assigned VDR state 1106 (SESS_ASSIGNED_VDR), a VDR provisioning request state 1108 (SESS_COI_PROV_REQ), and a VDR active state 1110 (SESS_COI_ACTIVE). Generally the null session state 1102 represents a VDR in an available pool and lacking any routing or association with a VPN IP address. Such VDRs have a service key loaded and an associated IP address. The VDR request state 1104, or starting state, generally has no routing, and is not associated with a VPN IP address. Rather, in this starting state the VDR broker 116 can create or start a container and start a Stealth service key mode, allowing the VDR to be allocated from the available pool.

The assigned VDR state 1106 still has no routing, but has a service key loaded and includes IP addresses. The assigned VDR state 1106 is associated with a VPN IP address, corresponding that VDR with a particular secure connection to a remote endpoint. However, a VDR in the assigned VDR state still has no community of interest material (keys, etc.) assigned, so communication by the endpoint within the Stealth network (e.g., private domain 104) is not yet enabled. In the VDR active state 1110, the VDR broker 116 has assigned the VDR 118 with routing information, an associated VPN IP address, and community of interest material. Furthermore, the VDR broker 116 has opened a license tunnel, allowing for validation of the COI material within the private domain 104, shown as a Stealth-enabled network.

In operation, an event manager included within the cleartext gateway device of the example embodiments described above tracks state transitions among the various states 1102-1110, which may transition based on actions taken by the VDR broker 116. Various actions may be performed, for example by a VDR manager service operating within the cleartext gateway device. In example embodiments, actions can include:
a session creation action 1120 (ACT_CREATE SESSION), which creates a session entry and assigns a session ID;
a request VDR action 1122 (ACT_REQ_VDR), which corresponds to a VDR request received at the VDR manager, and including a Client IP address and session ID. The request VDR action 1122 triggers a CONNECTION_START event passing a username and IP address of the endpoint seeking connection at the cleartext gateway device, and handled by the VDR broker 116.
a VDR assignment action 1124 (ACT_VDR_ASSIGN_COMPLETE), which reassigns a state to assign the VDR;
a VDR provisioning action 1126 (ACT_PROV_VDR), which sends a provision request to the VDR manager;
a VDR provisioning verification action 1128 (ACT_PROV_COMPLETE), which resets a state of the VDR to active, as noted below;
a VDR discarding action 1130 (ACT_VDR_DISCARD), which issues a VDR discard request to the VDR manager; and
a cleanup action 1132 (ACT_CLEANUP), which issues a VDR discard request to the VDR manager and frees session resources for reuse.

In the null session state 1102, receipt of a start connection request will cause the broker 116 to perform a session creation action 1120, transitioning the VDR to the VDR request state 1104. Receipt of a VDR assignment response (VDR_ASSIGN_RSP), which indicates that a VDR has been allocated, can trigger the VDR assignment action 1124, and, upon a VDR assignment action 1124 (ACT_VDR ASSIGN_COMPLETE), transition to the assigned VDR state 1106. The VDR assignment response can include, for example, a VDR ID, securer public key, and VDR IP addresses.

An authentication completion indication (AUTH_COMPLETE_IND), corresponding to a message from the authentication manager that a Stealth user has been authenticated by the authentication service 133, includes a username, gateway, and COI response from the authentication server, and triggers the VDR provisioning action 1126, which in turn transitions the VDR to a VDR provisioning request state 1108. From the VDR provisioning request state 1108, a VDR provisioning verification action 1128 will transition the VDR to a VDR active state 1110, upon occurrence of a verification message (VDR_PROV_COMPLETE) from the VDR manager. From the VDR active state 1110, a connection stop message (VPN_CONNECTION_STOP) indicating that a connection from the remote endpoint to the VDR has closed will cause transition to return to a VDR provisioning action 1126, triggering attempts to re-provision the VDR with the associated mobile device upon reconnection of the VPN tunnel.

Additionally, when in any of states 1106-1112, performance of a cleanup action 1132, or in states 1108-1112 performance of a VDR discarding action 1130, will transition the VDR to a null session state 1102, returning the VDR to an available pool by turning off all routing, disabling workgroups, and disassociating a VPN IP address (thereby disassociating the VDR from the mobile device and associated application). Such terminations may occur, for example, in response to a termination message received from the authentication manager.

Referring to FIG. 11 generally, it is noted that although a particular set of states and state transitions are disclosed, other states or transitions may be provided as well, for example to accommodate tracking of different types of VDR connections, VPN connections, or to further define instances in which terminations occur to determine a cause of such terminations.

Additional details regarding transition of states, and example services within a gateway that can perform such state transitions, are discussed in further detail in U.S. patent application Ser. No. ______, filed herewith, Attorney Docket No. TN624, and U.S. Provisional Patent Application No. 62/018,956, filed on Jun. 30, 2014, Attorney Docket No. TN624.P, the disclosures of both of which is hereby incorporated by reference in their entireties.

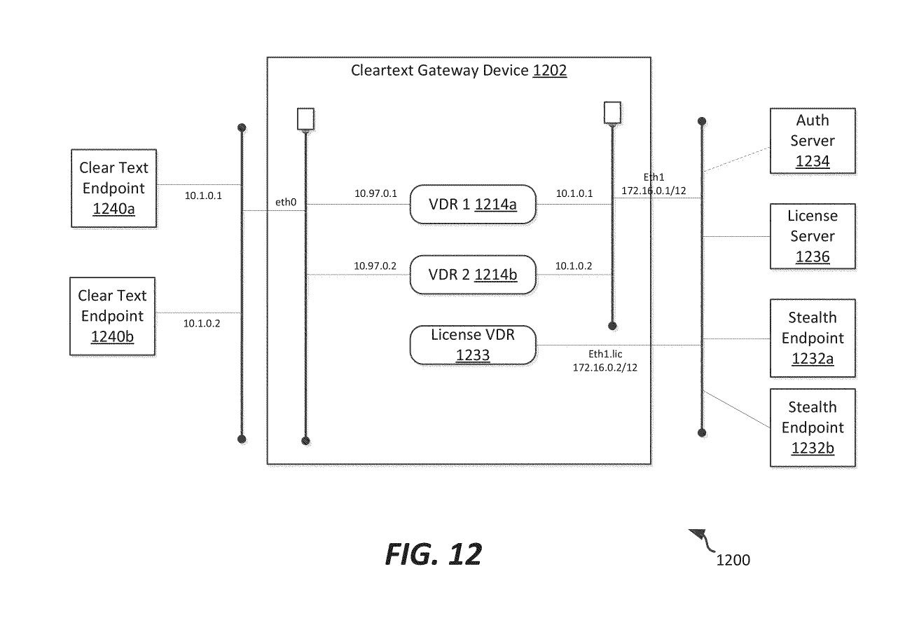

FIG. 12 illustrates a network topology 1200 incorporating a cleartext gateway device and allowing communication between cleartext endpoints and endpoints included in a secured enterprise network, according to an example embodiment. The network topology 1200 illustrates an effect of establishing cleartext communications among various endpoints that are accessible to a cleartext portion of a Stealth-enabled network. In the embodiment shown, the network topology includes a cleartext gateway device 1202 that is communicatively connected to a plurality of cleartext endpoints 1240a-b at a public domain side of the cleartext gateway device 1202 and Stealth-based systems on a secured enterprise side of the cleartext gateway device 1202. In particular, the secured enterprise side of the cleartext gateway device 1202 is connected to a plurality of endpoints 1232, shown as endpoints 1232a-b. The secured enterprise side of the cleartext gateway device 1202 is connected to an authentication server 1234 and a license server 1236.

As illustrated, each cleartext endpoint 1240a-b is associated with a particular public IP address. For example, as seen in FIG. 12, cleartext endpoint 1240a is assigned 10.1.0.1, and cleartext endpoint 1240b is assigned 10.1.0.2. To communicate with one or more endpoints 1232 within the secured enterprise network, each of the cleartext endpoints 1240a-b addresses data to a particular VDR 1214; as shown in the example of FIG. 12, cleartext endpoint 1240a addresses VDR 1 1214a, while cleartext endpoint 1240b addresses VDR 2 1214b. In either case, the cleartext gateway device 1202 acts as a routing hop between the cleartext endpoint 1240 and the Stealth endpoint 1232.

While license VDR 1233 maintains a license connection to a license server 1236 and adequate licenses exist, the VDRs 1214a-b will be allocated cleartext licenses, and assigned COI information. Accordingly, VDR 1 1214a can then relay data to endpoints (e.g., one or both of Stealth endpoints 1232a-b), the selection of which being defined by the community of interest memberships defined at the authentication server 1234. Similarly, those endpoints 1232 that are part of a common community of interest with a cleartext endpoint 1240 can directly address that cleartext endpoint 1240 by addressing data to the external IP address defined at the cleartext endpoint 1240, rather than requiring addressing of the VDR associated with that endpoint. Accordingly, for example Stealth endpoint 1232a can transmit data to cleartext endpoint 1240a by transmitting data to IP address 10.1.0.1. That IP address is also assigned, within the Stealth network side of the cleartext gateway device 1202, to the VDR 1214a associated with the cleartext endpoint 1240a assigned that IP address.

It is noted that, although two or more cleartext endpoints 1240 may each be configured to allow for cleartext access to Stealth endpoints 1232, such access is not necessarily common across those Stealth endpoints 1232, but is rather defined by the cleartext communities of interest associated with those endpoints. For example, COI keys and filters loaded into VDR 1 1214a may allow access by cleartext endpoint 1240 to both Stealth endpoints 1232a-b, while a separate set of COI keys and filters loaded into VDR 2 1214b (defined by the username and access credentials of a user at cleartext endpoint 1240b, and as stored in authentication server 1234) may only allow access to Stealth endpoint 1232b and not to Stealth endpoint 1232a. Various arrangements of cleartext communities of interest may be configured within the network topology 1200, as defined within the authentication server 1234.

Furthermore, to the extent the license server 1236 loses a connection to license VDR 1233, the license VDR may cause disconnection or shutdown of the VDRs 1214 entirely, interrupting communication between Stealth endpoints 1232 and cleartext endpoints 1240.

Although in the embodiment shown the cleartext gateway device 1202 implements VDRs 1214 in a “flat” configuration, it is understood that in some embodiments, such VDRs could be pooled to allow access to various sub-segments of a Stealth network. In such embodiments, VDR sets could be addressed in ranges, with each range being associated with a set of VDRs and associated accessible Stealth endpoints.

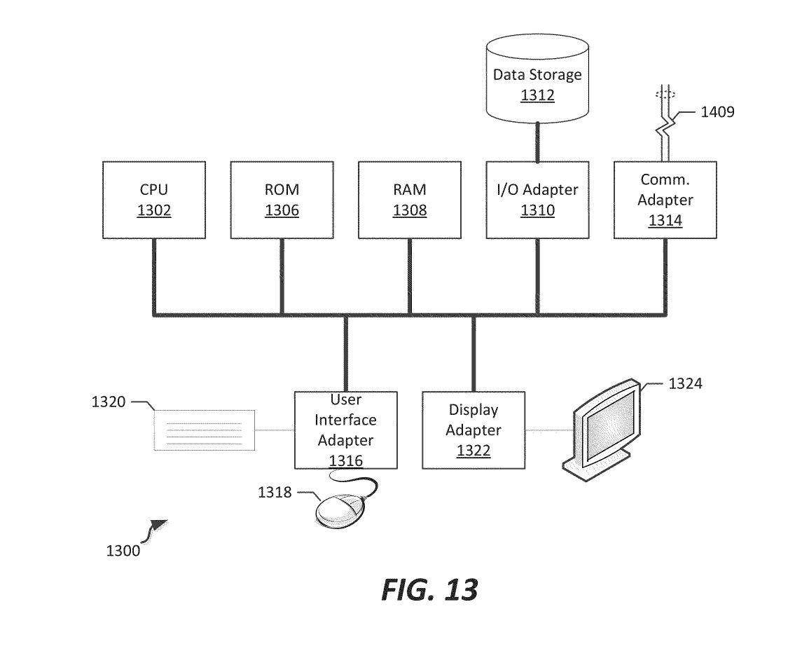

Referring to FIGS. 13-15, example details regarding computing systems in which aspects of the present disclosure can be implemented are provided. FIG. 13 illustrates a computer system 1300 adapted according to certain embodiments of the gateway computing device, server and/or the user interface device. The central processing unit (“CPU”) 702 is coupled to the system bus 1304. The CPU 1302 may be a general purpose CPU or microprocessor, graphics processing unit (“GPU”), and/or microcontroller. The present embodiments are not restricted by the architecture of the CPU 1302 so long as the CPU 1302, whether directly or indirectly, supports the operations as described herein. The CPU 1302 may execute the various logical instructions according to the present embodiments.

The computer system 1300 also may include random access memory (RAM) 1308, which may be synchronous RAM (SRAM), dynamic RAM (DRAM), synchronous dynamic RAM (SDRAM), or the like. The computer system 1300 may utilize RAM 1308 to store the various data structures used by a software application. The computer system 1300 may also include read only memory (ROM) 1306 which may be PROM, EPROM, EEPROM, optical storage, or the like. The ROM may store configuration information for booting the computer system 1300. The RAM 1308 and the ROM 1306 hold user and system data, and both the RAM 1308 and the ROM 1306 may be randomly accessed.

The computer system 1300 may also include an input/output (I/O) adapter 1310, a communications adapter 1314, a user interface adapter 1316, and a display adapter 1322. The I/O adapter 1310 and/or the user interface adapter 1316 may, in certain embodiments, enable a user to interact with the computer system 1300. In a further embodiment, the display adapter 1322 may display a graphical user interface (GUI) associated with a software or web-based application on a display device 1324, such as a monitor or touch screen.

The I/O adapter 1310 may couple one or more storage devices 1312, such as one or more of a hard drive, a solid state storage device, a flash drive, a compact disc (CD) drive, a floppy disk drive, and a tape drive, to the computer system 1300. According to one embodiment, the data storage 1312 may be a separate server coupled to the computer system 1300 through a network connection to the I/O adapter 1310. The communications adapter 1314 may be adapted to couple the computer system 1300 to the network 1409, which may be one or more of a LAN, WAN, and/or the Internet. The communications adapter 1314 may also be adapted to couple the computer system 1300 to other networks such as a global positioning system (GPS) or a Bluetooth network. The user interface adapter 1316 couples user input devices, such as a keyboard 1320, a pointing device 1318, and/or a touch screen (not shown) to the computer system 1300. The keyboard 1320 may be an on-screen keyboard displayed on a touch panel. Additional devices (not shown) such as a camera, microphone, video camera, accelerometer, compass, and or gyroscope may be coupled to the user interface adapter 1316. The display adapter 1322 may be driven by the CPU 1302 to control the display on the display device 1324. Any of the devices 1302-1322 may be physical and/or logical.

The applications of the present disclosure are not limited to the architecture of computer system 1300. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1300 may be virtualized for access by multiple users and/or applications.

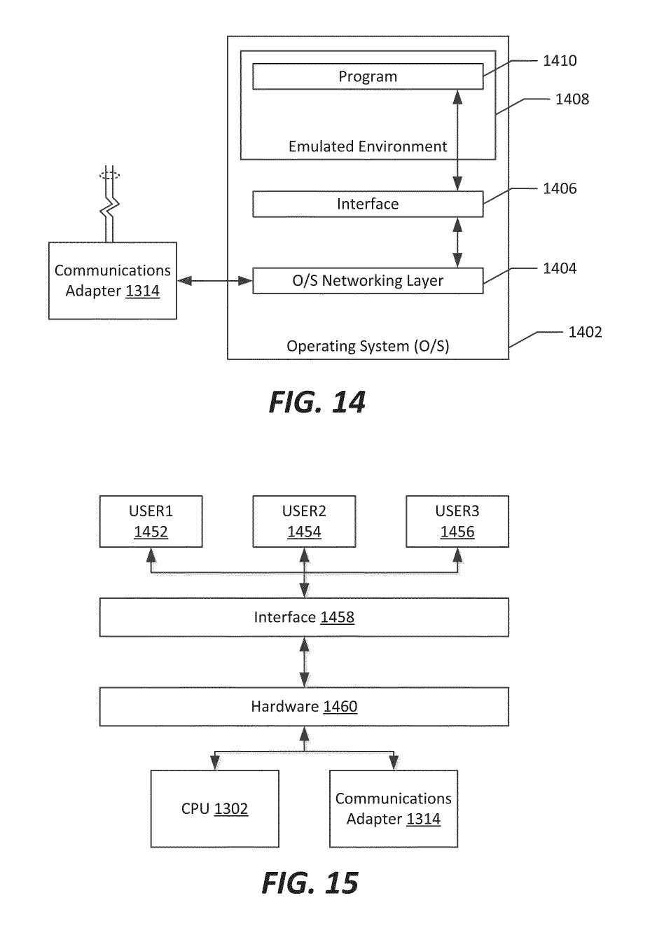

FIG. 14 is a block diagram illustrating a server hosting an emulated software environment for virtualization according to one embodiment of the disclosure. An operating system 1402 executing on a server includes drivers for accessing hardware components, such as a networking layer 1404 for accessing the communications adapter 1314. The operating system 1402 may be, for example, Linux. An emulated environment 1408 in the operating system 1402 executes a program 1410, such as CPCommOS. The program 1410 accesses the networking layer 804 of the operating system 1402 through a non-emulated interface 1406, such as XNIOP. The non-emulated interface 1406 translates requests from the program 1410 executing in the emulated environment 1408 for the networking layer 1404 of the operating system 1402.

In another example, hardware in a computer system may be virtualized through a hypervisor. FIG. 15 is a block diagram illustrating a server hosting an emulated hardware environment according to one embodiment of the disclosure. Users 1452, 1454, 1456 may access the hardware 1460 through a hypervisor 1458. The hypervisor 1458 may be integrated with the hardware 1460 to provide virtualization of the hardware 1460 without an operating system, such as in the configuration illustrated in FIG. 13. The hypervisor 1458 may provide access to the hardware 1460, including the CPU 1302 and the communications adapter 1314.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

Computer storage media generally includes at least some tangible, non-transitory media and can, in some embodiments, exclude transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as Wi-Fi, acoustic, radio frequency (RF), infrared, and other wireless media. In accordance with the present disclosure, the term computer readable media as used herein may include computer storage media, but generally excludes entirely transitory embodiments of communication media, such as modulated data signals.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Referring to FIGS. 1-14 generally, it is noted that the arrangements described herein provide a number of advantages over existing arrangements in terms of security, convenience, forward-compatibility, and flexibility for use with external, unaffiliated systems. For example, because of the use of dedicated VDRs for each external endpoint, the security settings of a particular private domain can be extended to that external endpoint (and data can be seamlessly communicated among VMs in the private and cloud environments) without a requirement of sharing community of interest keys or filters to the external computing system, ensuring the security of those keys and filters. Additionally, for trusted remote systems, such as remote trusted mobile devices, direct connection via a cleartext gateway is possible, thereby enabling communication between such devices and secure enterprise networks even in instances where the device exists within the secure enterprise network and secure connection (e.g., via VPN) is not typically performed.

The above specification, examples and data provide a complete description of the manufacture and use of the composition of the invention. Since many embodiments of the invention can be made without departing from the spirit and scope of the invention, the invention resides in the claims hereinafter appended.

1. A gateway computing system comprising:
a memory storing cleartext gateway software;
a programmable circuit communicatively connected to the memory and configured to execute computer-executable instructions including the cleartext gateway software, wherein execution of the cleartext gateway software by the programmable circuit causes the gateway computing system to:
instantiate at the gateway computing system a virtual device router including a cleartext interface configured to send and receive data packets from a cleartext endpoint and a secured interface configured to exchange data packets with one or more secured endpoints within a secured enterprise network;
load the virtual device router with community of interest material from an authentication server, the community of interest material associated with one or more communities of interest configured to allow access to the cleartext endpoint.

2. The gateway computing system of claim 1, wherein execution of the cleartext gateway software by the programmable circuit further causes the gateway computing system to instantiate a licensing virtual device router communicating with a licensing server within the secured enterprise network.

3. The gateway computing system of claim 2, wherein the licensing virtual device router includes stored community of interest key material based on material stored in a provisioning configuration directory stored in the memory of the gateway computing system.

4. The gateway computing system of claim 2, wherein execution of the cleartext gateway software by the programmable circuit further causes the gateway computing system to instantiate a licensing tunnel between the licensing virtual device router and the licensing server.

5. The gateway computing system of claim 1, wherein execution of the cleartext gateway software by the programmable circuit further causes the gateway computing system to:
assign a first IP address to the cleartext interface; and
assign a second IP address to the secured interface, the second IP address being different from the first IP address.

6. The gateway computing system of claim 1, wherein loading the virtual device router with community of interest material from the authentication server includes:
obtaining the community of interest material from the authentication server;
establishing one or more IP rules and routing tables useable to route traffic between the cleartext endpoint and the secured enterprise network;
applying one or more filter rules at the virtual device router; and
storing the community of interest material in the virtual device router.

7. The gateway computing system of claim 1, wherein the cleartext endpoint is positioned external to the secured enterprise network.

8. The gateway computing system of claim 1, wherein the virtual device router allows communication with the cleartext endpoint without establishing a secure connection between the cleartext endpoint and the cleartext interface of the virtual device router.

9. The gateway computing system of claim 8, wherein data exchanged between the cleartext endpoint and the cleartext interface of the virtual device router is secured by at least one of the cleartext endpoint and an endpoint within the secured enterprise network.

10. The gateway computing system of claim 1, further comprising a plurality of virtual device routers, each of the plurality of virtual device routers associated with a different endpoint and allowing communication between that respective endpoint and the secured enterprise network.

11. The gateway computing system of claim 10, further comprising an administrative interface providing management of each of the plurality of virtual device routers.

12. A method of routing traffic between a cleartext endpoint and a secured enterprise network, the method comprising:
instantiating at a gateway computing system a virtual device router associated with the cleartext endpoint; the virtual device router including a cleartext interface configured to send and receive data packets from the cleartext endpoint and a secured interface configured to exchange data packets with one or more secured endpoints within the secured enterprise network;
loading the virtual device router with community of interest material from an authentication server, the community of interest material associated with one or more communities of interest configured to allow access to the cleartext endpoint.

13. The method of claim 12, further comprising:
assigning a first IP address to the cleartext interface;
assigning a second IP address to the secured interface, the second IP address being different from the first IP address; and
defining a routing table that establishes routing of data received at the virtual device router among endpoints including the cleartext endpoint and one or more endpoints within the secured enterprise network.

14. The method of claim 13, further comprising:
receiving data from the cleartext endpoint at the cleartext interface, the data received in encrypted form over a cleartext connection between the cleartext endpoint and the cleartext interface;
routing the data to an intended destination within the secured enterprise network based on the routing table.

15. The method of claim 12, further comprising instantiating at the gateway computing system a second virtual device router separate from the virtual device router and associated with a second cleartext endpoint different from the cleartext endpoint.

16. The method of claim 12, further comprising receiving an administrative command at the gateway computing system disabling the virtual device router.

17. The method of claim 12, further comprising, prior to loading the virtual device router with community of interest material from the authentication server, authenticating the gateway computing system at a licensing server.

18. The method of claim 12, wherein authenticating the gateway computing system at a licensing server comprises:
instantiating a licensing virtual device router at the gateway computing system;
establishing a license tunnel between the licensing virtual device router and the licensing server.

19. The method of claim 18, further comprising:
periodically determining a status of the license tunnel;
upon determining that the license tunnel is interrupted, disabling the virtual device router at least until the license tunnel is reinstantiated.

20. A secured enterprise network allowing connection to a cleartext endpoint, the secured enterprise network comprising:
a plurality of secured endpoints configured to exchange secured communications among endpoints sharing a common community of interest;
a gateway computing system communicatively connected to the plurality of secured endpoints, the gateway computing system including:
a virtual device router including a cleartext interface configured to send and receive data packets from the cleartext endpoint and a secured interface configured to exchange data packets with one or more secured endpoints within the secured enterprise network;
wherein the virtual device router includes community of interest material from an authentication server, the community of interest material associated with one or more communities of interest configured to allow access to the cleartext endpoint.
